(19) United States
(12) Patent Application Publication
(10) Pub. No.: US 2019/0257362 A1
(43) Pub. Date: Aug. 22, 2019

(54) TRIPOD ROLLER FOR A CONSTANT VELOCITY UNIVERSAL JOINT

(71) Applicant: Schaeffler Technologies AG & Co. KG, Herzogenaurach (DE)

(72) Inventors: Christophe Walliser, Haguenau (FR); Xavier Mehul, Rosheim (FR); Eric Moschler, Haguenau (FR); Gabriel Dalstein, La Petite Pierre (FR); Jean-Philippe Dietrich, Drusenheim (FR)

(73) Assignee: Schaeffler Technologies AG & Co. KG, Herzogenaurach (DE)

(21) Appl. No.: 16/330,951

(22) PCT Filed: Sep. 22, 2017
(86) PCT No.: PCT/DE2017/100807

§ 371 Date: Mar. 6, 2019

(30) Foreign Application Priority Data
Oct. 6, 2016 (DE) 10 2016 219 419.4

(51) Int. Cl. F16D 3/205

(52) U.S. Cl. CPC F16D 3/2055; F16D 2003/2026

(57) ABSTRACT

A tripod roller for a constant velocity universal joint includes inner and outer rings separated by a set of rollers. During assembly of the tripod roller the rollers are assembled to one of the inner and outer rings and then the other of the inner and outer rings is moved axially into position. Then, a forming tool is applied to one of the rings, in a direction perpendicular to the roller axis, to create a securing region. The securing region prevents relative axial movement of the two rings during the assembly of the universal joint.

### CROSS-REFERENCE TO RELATED APPLICATIONS

This application is the U.S. National Phase of PCT Appln. No. PCT/DE2017/100807 filed Sep. 22, 2017, which claims priority to DE 10 2016 219 419.4 filed Oct. 6, 2016, the entire disclosures of which are incorporated by reference herein.

### TECHNICAL FIELD

The disclosure concerns a tripod roller for a constant velocity universal joint with a form-fit securing region, a constant velocity universal joint with at least one of these tripod rollers, and a method for assembling the tripod roller.

### BACKGROUND

Constant velocity universal joints are joints for transmitting an angular speed and a torque in a constant manner from one shaft to another shaft which is attached thereto at an angle. For example, constant velocity universal joints are used to transmit a drive torque from a motor to the wheels of a steered axle of a vehicle.

One design of constant velocity universal joints is tripod joints which often comprise, as a joint partner, a tripod star with pegs, wherein the pegs are oriented radially relative to the joint partner and each carry a tripod roller. The tripod star with the tripod rollers engages in an axle journal as a second joint partner; said axle journal has three elongate recesses which run axially relative to the second joint partner and in which the three tripod rollers can move axially relative to the second joint partner.

An example of such a constant velocity universal joint is disclosed in publication DE 44 39 965 A1. The publication discloses a tripod unit in which a form-fit coupling exists directly between an outer ring of a tripod roller and an inner ring of the tripod roller, and the inner ring has a ring shoulder which bears against the end face on the outer ring of the tripod roller.

### SUMMARY

It is an object of the disclosure to propose a tripod roller which is cheap to produce, a corresponding constant velocity universal joint with the tripod roller, and a method for assembling the tripod roller. Preferred or advantageous embodiments arise from the following description and the enclosed figures.

The constant velocity universal joint is in particular configured as a constant velocity sliding joint. In particular, the constant velocity universal joint is configured as a homokinetic joint for even transmission of angular speed and torque from one shaft to a second shaft which may be attached at an angle thereto. The constant velocity universal joint may be configured as a transmission joint for transmitting a drive torque from a motor to steered wheels of a vehicle. In particular, the constant velocity universal joint is arranged between an axle gear mechanism and a drive shaft. The constant velocity universal joint has a tripod star as the first joint partner, with three pegs extending radially relative to an axis of the tripod star. A tripod roller is placed on each peg. The tripod star engages in an axle journal as a second joint partner, wherein the axle journal has three elongate recesses which run axially relative to the second joint partner and in which the three tripod rollers can move axially relative to the second joint partner.

The tripod roller comprises an inner ring for positioning on the tripod star, in particular on one of the pegs of the tripod star. Furthermore, the tripod roller comprises an outer ring, wherein the outer ring is arranged coaxially relative to the inner ring. The inner ring and outer ring are designated below jointly as rings. The rings are also arranged coaxially to a tripod roller axis which is defined by the pegs of the tripod star. In a longitudinal section along the tripod roller axis, the outer ring may have a convex and/or ball-segment-like exterior.

The tripod roller comprises a plurality of rollers, such as cylinder rollers or needle rollers, wherein the rollers are arranged so as to roll between the rings. The rollers are aligned in the same direction and/or oriented parallel to the tripod roller axis. The rollers may be arranged in a single row.

At least one of the rings may be formed as a securing ring having a securing region, in particular a form-fit securing region, wherein the securing region is designed as an embossing region and/or caulking region. The securing region may be produced as a formed region, wherein the final shape of the securing region is produced by forming.

From a functional aspect, the securing region may be arranged such that it axially secures the other ring and/or at least one, some or all of the rollers in a form-fitting manner as a securing partner. Thus the securing region is designed such that an axial displacement of the other ring and/or the rollers in the direction of the securing region is prevented by the securing region, in particular in a form-fitting manner.

The securing region may be formed as a region of the securing ring configured as an interference contour for the other ring and/or the rollers in the radial direction relative to the tripod roller axis. In particular, the securing region may be formed as an integral part of the securing ring and/or as one piece and/or as one part and/or integrally with the securing ring.

The securing region may be formed not by a prior separating process step, such as e.g. milling etc., or by a prior forming step with greater material flux, but merely by embossing and/or caulking. Thus in comparison with a separating process, a complex working step is saved and in comparison with the forming process, the degree of forming is significantly reduced, so that the problems resulting from a forming step with a high forming degree cannot occur. Thus, for example, it is possible that the securing region is hardened or that the form of the securing ring is changed so little by the embossing and/or caulking that there is no need for shaping re-machining in the region of the raceway. Thus the tripod roller may be produced more cheaply.

The securing region may form an axial end stop for the securing partner. Thus the securing region prevents the securing partner, namely the other ring and/or the rollers, from being able to run out axially against the securing region. Thus as well as economic production, the assembly and handling are also simplified, giving further cost benefits in production of the tripod roller.

The securing region may be produced by a forming tool with an action direction running axially against the securing region. By forming the ring in this way, it is achieved that the material flows radially in a shoulder region of the ring and thereby forms the securing region. In particular, during forming, the securing ring is only counter-supported in the axial direction.

The securing region may be formed as a continuous and/or an interrupted region around the tripod roller axis. This has the advantage that a rotational symmetry of the securing ring remains guaranteed and the ring is therefore more stable.

Alternatively, the securing region may be formed as several part regions running with interruptions around the tripod roller axis. For example, it may be sufficient for only a limited number of part regions, for example three or four part regions, to be formed by such embossing or caulking in order to form the securing region. The securing region can be produced particularly cheaply in the securing ring, since the force required for forming and the resulting load on the securing ring are comparatively low.

In a first possible embodiment, the ring is hardened in portions. For example, the raceway for the rollers is hardened. It is however provided that the securing region is not hardened. In this embodiment, it is particularly easy to form the ring for producing the securing region by means of embossing and/or caulking.

It has however proved advantageous if the securing region can be produced by embossing and/or caulking even if the securing region is hardened. Thus it is particularly preferred if the securing ring is fully hardened and for example through-hardened. This allows production of a hardened ring with the securing region at low cost. In particular, the securing region is made in the hardened ring.

The securing ring may be formed as a raceway side and/or without a rim on at least one side, in particular on at least one axial side. On this side, in particular on the raceway side, the securing region is formed as a radial overhang relative to a raceway or as an extension of the raceway of the securing ring. In a refinement, both sides of the securing ring are formed as a raceway side and/or without a rim, wherein such an overhang is formed on each side as a securing region.

Alternatively, the securing region may form a form-fit securing element for at least one, some or all of the rollers of the tripod roller, since these cannot be pushed out in the axial direction beyond the securing region.

In another alternative, at least one or precisely one rim of the other ring is dimensioned radially so that this cannot be pushed out in the axial direction beyond the securing region, so that the securing region secures the other ring by form fit in this axial direction. In a refinement, both rims of the other ring are dimensioned accordingly and the securing ring has two securing regions, such that the securing regions secure the other ring by form fit in both axial directions.

In another embodiment, the securing ring has a rim, wherein the securing region is formed as a radial overhang relative to the rim. In this embodiment, it is provided that the securing region secures the other ring by form fit in the axial direction.

In an alternative to this embodiment, the other ring has a rim on the same side, wherein the rim of the other ring runs axially against the securing region. In another alternative embodiment, the other ring has no rim but has a raceway side, and/or is formed without a rim, wherein the other ring runs out at the radial height of the raceway. In this embodiment, the other ring runs against the securing region and is thereby axially secured.

It may be provided that the other ring has a throat region, wherein the throat region faces the securing region. In particular, the throat region is circumferential. It is preferred if the throat region is arranged overlapping with the securing region, in particular in the radial direction. The throat region is formed as a clearance or cutout. The throat region ensures a jump in diameter of the other ring, so that the form-fit securing element also engages abruptly when the rings are displaced relative to each other, and does not lead to seizing. In particular, the axial width of the shoulder ring may be reduced by the throat region.

A constant velocity universal joint includes at least one tripod roller as described above.

In a first step of a method for assembling the tripod roller described above, the rollers are arranged between the rings. In a later step, the ring is caulked and/or embossed in order to create the securing region. This allows simple assembly of the tripod roller, wherein the assembly is secured against loss and/or the assembly transforms into a self-retaining assembly in the partly mounted or fully mounted state. This is achieved in that the side of the securing ring is embossed and/or caulked only after assembly in order to create the securing region.

### BRIEF DESCRIPTION OF THE DRAWINGS

Further features, advantages and effects arise from the description below of a preferred exemplary embodiment, and from the enclosed figures.

FIG. 1 shows a highly diagrammatic depiction of a constant velocity universal joint with a tripod roller.

FIG. 2 shows a diagrammatic, longitudinal, sectional depiction of the tripod roller from FIG. 1.

FIG. 3 shows a detail of the tripod roller from FIG. 2.

FIGS. 4a and 4b show a further exemplary embodiment of the tripod roller for the constant velocity universal joint from FIG. 1.

FIGS. 5a and 5b show a further exemplary embodiment of the tripod roller for the constant velocity universal joint from FIG. 1.

FIGS. 6a and 6b show a further exemplary embodiment of the tripod roller for the constant velocity universal joint from FIG. 1.

FIGS. 7a and 7b show a further exemplary embodiment of the tripod roller for the constant velocity universal joint from FIG. 1.

FIGS. 8a and 8b show a further exemplary embodiment of the tripod roller for the constant velocity universal joint from FIG. 1.

### DETAILED DESCRIPTION

The same or corresponding parts carry the same or corresponding reference signs.

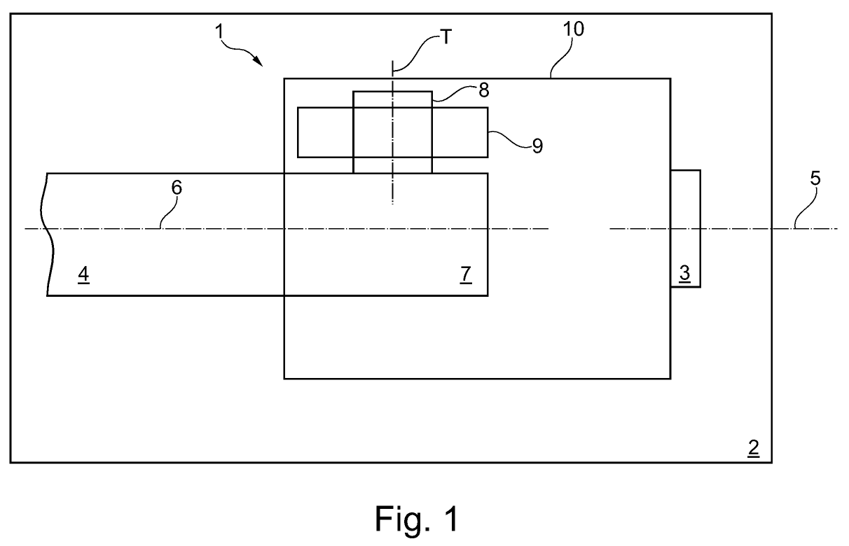

FIG. 1 shows, in a highly diagrammatic depiction, a constant velocity universal joint 1 for a vehicle 2, which is indicated merely as a block.

The constant velocity universal joint 1 is arranged in the drive train between a gear output 3, in particular of a differential gear, and an intermediate shaft 4, in particular a wheel drive shaft or cardan shaft. The gear output 3 defines an output axis 5, the intermediate shaft 4 defines a shaft axis 6. The constant velocity universal joint 1 is configured to transmit a rotation and hence a drive torque from the output 3 to the intermediate shaft 4, and at the same time allow a pivoting or angular change between the output axis 5 and the shaft axis 6, such as can occur for example on suspension compression of a driven wheel connected to the intermediate shaft 4. The intermediate shaft 4 comprises a shaft stub portion 7 provided with a plurality of pegs 8, in this exemplary embodiment three pegs 8, which extend radially relative to the shaft axis 6. The pegs 8 are distributed regularly around the shaft axis 6 in the circumferential direction so as to form a tripod star. FIG. 1 shows merely one of the pegs 8 graphically. A tripod roller 9 is arranged on each peg 8 and has a tripod roller axis T as a rotation axis which is arranged radially relative to the shaft axis 6.

The constant velocity universal joint 1 furthermore has an axle journal portion 10 which is coupled rotationally fixedly to the output 3 and which provides raceways for the tripod rollers 9.

While FIG. 1 shows an exemplary embodiment in which the axle journal portion 10 is coupled rotationally fixedly to the output 3 and the shaft stub portion 7 is coupled rotationally fixedly to the intermediate shaft 4, in other exemplary embodiments it is also possible that the shaft stub portion 7 is coupled rotationally fixedly to the output 3 and the axle journal portion 10 is coupled to the intermediate shaft 4. It is furthermore possible that the axle journal portion 10 is configured so as to be peripherally closed or has free regions.

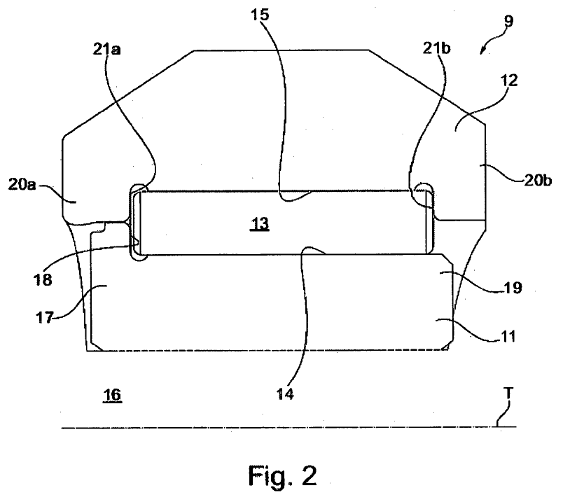

FIG. 2 shows in a diagrammatic depiction the tripod roller 9 from FIG. 1. The tripod roller 9 has an inner ring 11 and an outer ring 12 which are arranged coaxially to the tripod roller axis T. A plurality of roller bodies 13 is arranged between the inner ring 11 and the outer ring 12, wherein the roller bodies 13 are configured as rollers 13 and here in particular as needle rollers. The rollers 13 are oriented parallel to the tripod roller axis T. The inner ring 11 provides an inner raceway 14, the outer ring 12 provides an outer raceway 15, wherein the rollers 13 roll along the inner raceway 14 and outer raceway 15. Radially on the outside, the outer ring 12 is configured curved so as to be adapted to the axle journal portion 10. In particular, in the longitudinal sectional depiction shown, the outer ring 12 has a circular contour.

The inner ring 11 has a receiver 16 for a peg 8 of the shaft stub portion 7.

The inner ring 11 has a shoulder side 17, wherein the shoulder side 17 is configured as a rim and forms an axial stop for the rollers 13. In particular, the shoulder side 17 has a stop face 18 running in a radial plane relative to the tripod roller axis T. The stop face 18 does not however extend over the complete radial extension of the roller 13 but runs only up to the middle of the roller 13.

On the opposite axial side, the inner ring 11 is configured with a raceway side 19, wherein the raceway side 19 is either slightly set back relative to the inner raceway 14 or runs at least mostly in the same radial diameter. In principle therefore, the roller body 13 may be inserted into the inner ring 11 via the raceway side 19.

The outer ring 12 however is configured as a securing ring which has two shoulder sides 20a, b. Each of the shoulder sides 20a, b is configured as a rim and forms a stop for the roller body 13. Each of the sides has a stop face 21a, b which also lies in a radial plane relative to the tripod roller axis T.

Looking at the shoulder sides 17, 20a, b, the tripod roller 9 is secured by form fit in one direction against a shift of the outer ring 12 relative to the inner ring 11. It is however possible for the outer ring 12 to be moved to the right in FIG. 2, i.e. in the direction of the raceway side 19 of the inner ring 11, so that during assembly the tripod roller 9 can fall apart.

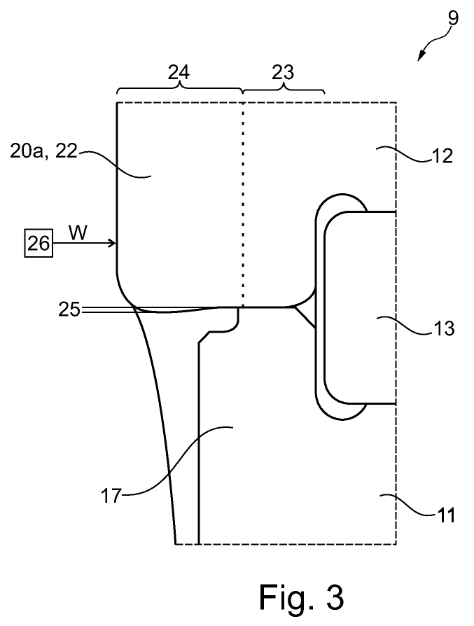

This is however prevented by the form-fit securing element, as explained in connection with FIG. 3. FIG. 3 shows a detail extract of the tripod roller 9 in the region of the shoulder sides 17, 20a. It is evident that the shoulder side 20a of the outer ring 12 is configured as a terminating shoulder side 22 which can be broken into two regions by axial division.

One part region 23, which directly adjoins the roller body 13, has a cylindrical casing surface arranged coaxially to the tripod roller axis T. Furthermore, this part region 23 is positioned opposite the shoulder side 17 of the assembly ring and/or inner ring 11. A securing region 24 adjoins the part region 23 and is formed by a caulking region and/or embossing region. The securing region 24 protrudes radially relative to the part region 23 by an overhang 25, as indicated by the two straight lines in FIG. 3. The overhang 25 is dimensioned such that the inner ring 11 cannot run out in the direction of the terminating side 22 and is therefore secured by form fit in this direction. The overhang 25 may be configured so as to be continuously circumferential. It is however also possible, in particular as shown in FIG. 3, for the overhang 25 to be provided only at a few positions regularly spaced apart from each other for example in the circumferential direction. The overhang 25 is in particular produced by a forming tool 26 which is pressed or pushed axially with its action direction W against the outer ring 12.

A throat region 27 is made on the shoulder side 17 of the assembly ring and/or inner ring 11 as a clearance. The throat region 27 may for example be formed as a separation. The throat region 27 is open axially towards the outside and/or faces the securing region 24. Without the throat region 27, the shoulder ring and/or outer ring 12 would have to be made wider in the region of the terminating shoulder side 22 in order to ensure that, in normal operation, the shoulder side 17 of the assembly ring and/or inner ring 11 does not come into contact with the terminating shoulder side 22. The stability of the shoulder side 17 is not significantly reduced by the throat region 27, however the securing region 24 and the shoulder side 17 may be placed close together in the axial direction.

On a possible production of the tripod roller 9, in a first step the inner ring 11, outer ring 12 and roller bodies 13 are mounted, and then the securing region 24 is produced by forming, namely by embossing and/or caulking.

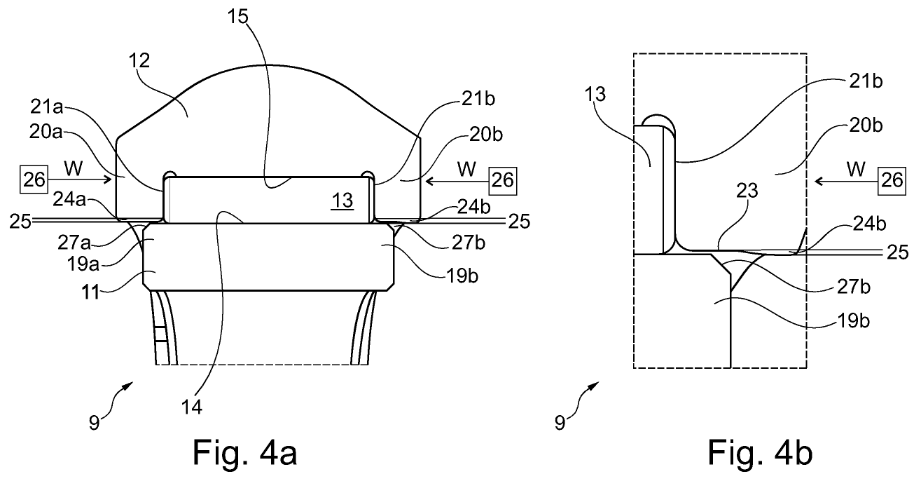

In the tripod roller 9 in FIGS. 4a, b, the inner ring 11 has two raceway sides 19a, b, wherein the raceway sides 19a, b are arranged radially at the same distance as the inner raceway 14, or on the edge side are radially set back relative to the inner raceway 14 by throat regions 27a, b which in this case are formed as chamfers.

The outer ring 12 however has two shoulder sides 20a, b with rims, wherein the rims have a free inner diameter which is only slightly larger than the outer diameter of the inner raceway 14. The outer ring 12 is formed as a securing ring and has two securing regions 24, which again adjoin a part region 23 with a cylinder casing surface arranged coaxially to the tripod roller axis T. The securing region 24a, b is in each case configured as a caulking region and/or embossing region which protrudes radially inwardly relative to the part region 23 by an overhang 25, as indicated by the two straight lines in FIGS. 4a, b. The overhang 25 is dimensioned such that the inner ring 11 cannot run out in the direction of the shoulder sides 20a, b and hence is secured by form fit in both axial directions. As before, the overhang 25 may be configured so as to be continuously circumferential, or be provided only at a few positions which are for example regularly spaced apart from each other in the circumferential direction. The overhang 25 is formed in particular by the forming tool 26 which is pushed or pressed axially with its action direction W against the outer ring 12.

In production of this tripod roller 9 too, it is also possible that in a first step the inner ring 11, outer ring 12 and roller bodies 13 are mounted and then the securing region 24a, b is produced by forming, namely embossing and/or caulking.

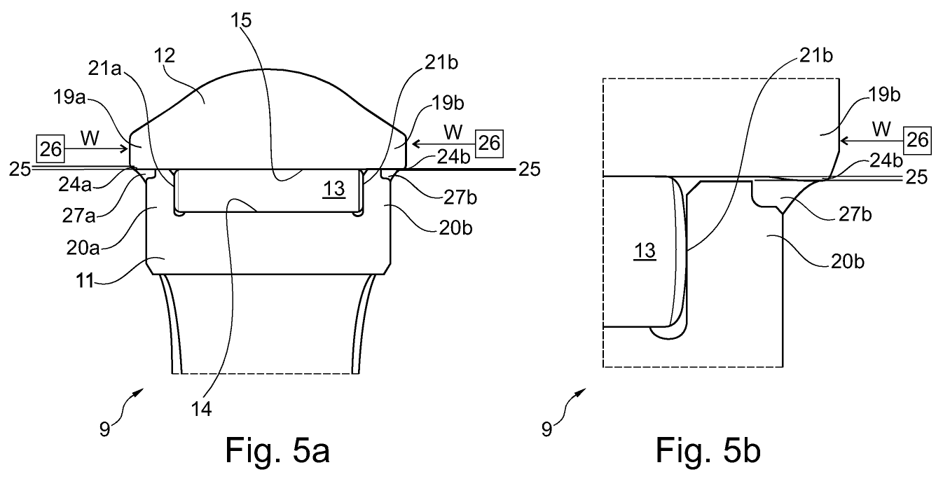

FIGS. 5a, b show a further exemplary embodiment of a tripod roller 9 for the constant velocity universal joint 1 in FIG. 1. In this exemplary embodiment, the inner ring 11 has two shoulder sides 20a, b which enclose the roller bodies 13. The outer ring 12 however has two raceway sides 19a, b, wherein the outer ring 12 as a securing ring carries a securing region 24a, b on each raceway side 19a, b. Without the securing region 24a, b, the raceway sides 19a, b are in the same radial position relative to the outer raceway 15 or are set back radially towards the outside. The shoulder sides 20a, b have a radial outer diameter which is only slightly smaller than the free inner diameter of the outer raceway 15. Axially on the outside, the shoulder sides 20a, b each have a throat region 27a, b facing the securing region 24a, b. The securing region 24a, b protrudes radially towards the inside relative to the outer raceway 15 and is dimensioned such that it constitutes an axial end stop and thus a form-fit securing element for the shoulder sides 20a, b and hence for the inner ring 11.

On assembly, firstly the roller bodies 13 may be laid in the inner ring 11 and this, together with the roller bodies 13, is pushed into the outer ring 12, since initially the free diameter of the raceway sides 19a, b is greater than the outer diameter of the shoulder sides 20a, b. In this assembled state, the forming tool 26 with an axial, in particular a purely axial, action direction W, may produce the securing regions 24a, b in the outer ring 12 by means of caulking and/or embossing.

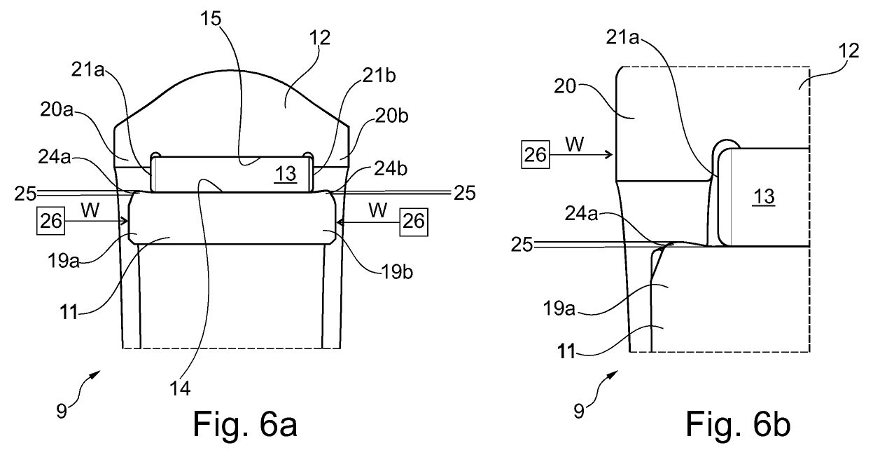

FIGS. 6a, b show a further exemplary embodiment of the tripod roller 9 in the constant velocity universal joint 1 of FIG. 1. In this exemplary embodiment, the outer ring 12 has two shoulder sides 20a, b with rims which hold the roller bodies 13 by form fit in both axial directions. The inner ring 11 however has two raceway sides 19a, b, wherein the securing regions 24a, b are made in the raceway sides 19a, b. In this exemplary embodiment, the securing regions 24a, b do not however secure the outer ring 12 directly, but only indirectly via the roller bodies 13. The securing regions 24a, b are dimensioned with the overhang 25 on the raceway sides 19a, b such that these form a form-fit securing element for the roller bodies 13 in both axial directions. Since the roller bodies 13 are held in place on both sides by the shoulder sides 20a, b of the outer ring 12, the outer ring 12 is thus also indirectly secured by form fit.

On assembly, the roller bodies 13 are first laid in the outer ring 12, then the inner ring 11 is inserted and then caulked and/or embossed by means of the forming tool 26, as has been described above.

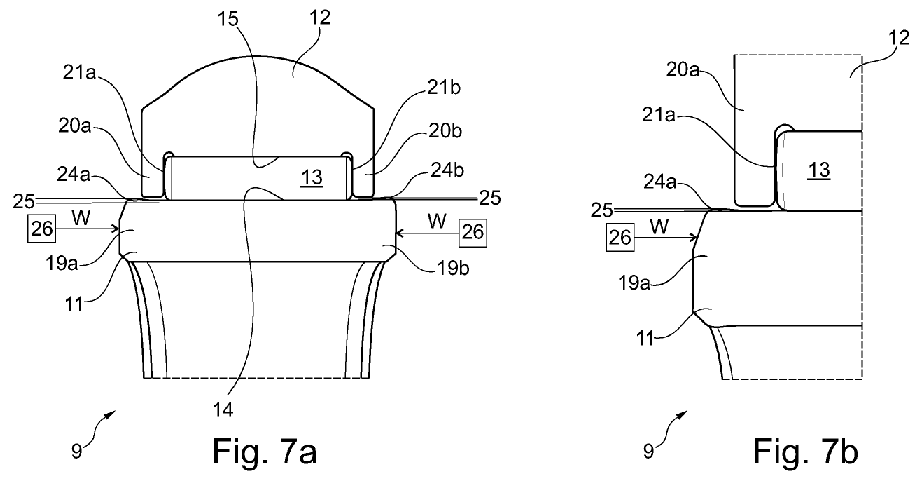

FIGS. 7a, b show a further exemplary embodiment of the tripod roller 9 for the constant velocity universal joint 1 in FIG. 1. This exemplary embodiment is constructed similarly to the exemplary embodiment of FIGS. 6a, b, wherein the rims of the shoulder sides 20a, b of the outer ring 12 are drawn further down in the direction of the inner ring 11, and the securing regions 24 are arranged axially further towards the outside so that they enclose the inner ring 11, in particular the shoulder sides 20a, b. In contrast to the exemplary embodiment in FIGS. 6a, b, the securing regions 24a, b therefore hold the shoulder sides 20a, b, and hence the outer ring 12, by form fit against slipping outward in the axial direction.

On assembly, the roller bodies 13 are first laid in the outer ring 12, then the inner ring 11 is inserted and then caulked and/or embossed by means of the forming tool 26, as has been described above.

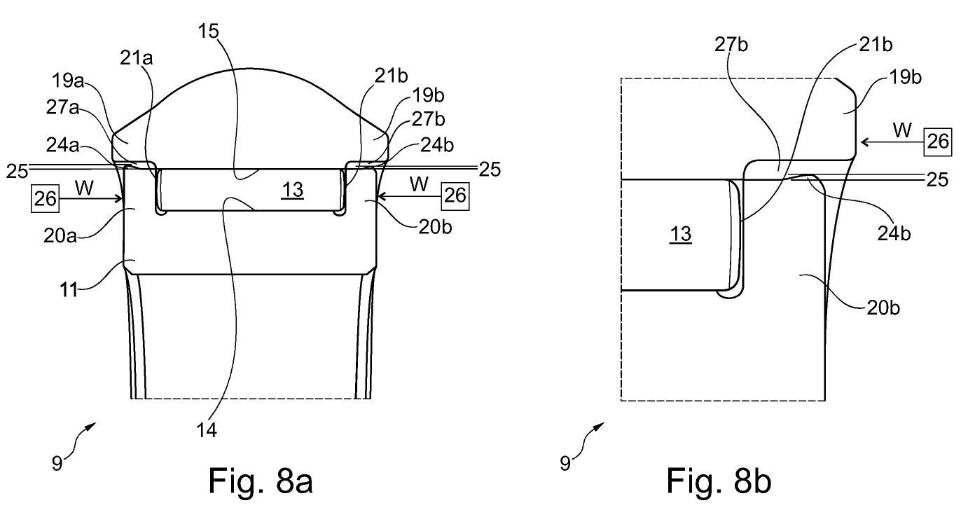

FIGS. 8a, b show a final exemplary embodiment of the tripod roller 9 of the constant velocity universal joint 1 in FIG. 1, wherein the inner ring 11 has two shoulder sides 20a, b. The outer ring 12 however has two raceway sides 19a, b, which both have a throat region 27a, b in the same axial region as the rims of the shoulder sides 20a, b. Thus the raceway sides 19a, b are offset radially towards the outside relative to the outer raceway 15 and accordingly set back relative to the outer raceway 15. The securing regions 24a, b are arranged on the shoulder sides 20a, b and dimensioned such that the overhang 25 forms a form-fit securing element relative to the outer ring 12 in the region of the outer raceway 15.

On assembly, the roller bodies 13 are first laid in the inner ring 11, then the outer ring 12 is pushed on and then caulked and/or embossed by means of the forming tool 26, as has been described above.

### LIST OF REFERENCE SIGNS

1 Constant velocity universal joint
2 Vehicle
3 Gear output
4 Intermediate shaft
5 Output axis
6 Shaft axis
7 Shaft stub portion
8 Peg
9 Tripod roller
10 Axle journal portion
11 Inner ring
12 Outer ring
13 Roller body
14 Inner raceway
15 Outer raceway
16 Receiver
17 Shoulder side
18 Stop face
19 Raceway side
20 Shoulder sides
21 a, b Stop faces
22 Terminating shoulder side
23 Part region
24, 24 a, b Securing region
25 Overhang
26 Forming tool
27, 27 a, b Throat region
T Tripod roller axis
W Action axis

1. A tripod roller for a constant velocity universal joint, the tripod roller comprising:
an inner ring and an outer ring arranged coaxially to a tripod roller axis; and
a plurality of rollers arranged so as to roll between the inner ring and the outer ring; and
wherein a first of the inner ring and the outer ring being a securing ring having a securing region, wherein the securing region is designed as an embossing region or caulking region, wherein the securing region axially secures a second of the inner ring and the outer ring or at least one of the rollers in a form-fitting manner as a securing partner.

2. The tripod roller of claim 1 wherein the securing region forms an axial end stop for the securing partner.

3. The tripod roller of claim 1 wherein the securing region is produced by a forming tool with an action direction running axially against the securing region.

4. The tripod roller of claim 1 wherein the securing ring is hardened in portions, wherein the securing region is not hardened.

5. The tripod roller of claim 1 wherein the securing region is hardened.

6. The tripod roller of claim 1 wherein the securing ring is formed without a rim on a first raceway side, wherein on the first raceway side, the securing region is formed as a radial overhang relative to a raceway of the securing ring.

7. The tripod roller of claim 1 wherein the securing ring has a rim on one shoulder side, wherein the securing region is formed on the shoulder side as a radial overhang relative to the rim.

8. The tripod roller of claim 1 wherein the second of the inner ring and the outer ring has a throat region, wherein the throat region faces the securing region.

9-10. (canceled)

11. A constant velocity universal joint comprising:
first and second rings arranged coaxially with respect to a tripod roller axis; and
a plurality of rollers arranged to roll between the first and second rings; and
wherein the first ring has a securing region which axially secures the second ring in a form-fitting manner.

12. The constant velocity universal joint of claim 11 wherein the securing region forms an axial end stop for the second ring.

13. The constant velocity universal joint of claim 11 wherein the first ring is hardened in portions, wherein the securing region is not hardened.

14. The constant velocity universal joint of claim 11 wherein the first ring is formed without a rim on a first raceway side, wherein on the first raceway side, the securing region is formed as a radial overhang relative to a raceway of the securing ring.

15. The constant velocity universal joint of claim 11 wherein the first ring has a rim on one shoulder side, wherein the securing region is formed on the shoulder side as a radial overhang relative to the rim.

16. The constant velocity universal joint of claim 11 wherein the first ring is an inner ring and the second ring is an outer ring.

17. The constant velocity universal joint of claim 11 wherein the first ring is an inner ring and the second ring is an outer ring.

18. A method of assembling a tripod roller for a universal joint, the method comprising:
arranging a plurality of rollers between an inner ring and an outer ring to facilitate relative rotation about a roller axis; and
using a forming tool in a direction perpendicular to the roller axis to create a securing region on one of the inner ring and the outer ring, thereby axial securing the inner ring and outer ring to one another.
